(19) United States
(12) Patent Application Publication
(10) Pub. No.: US 2005/0180591 A1
(43) Pub. Date: Aug. 18, 2005

(54) Speaker

(75) Inventors: Yasuhisa Abe, Yamagata-ken (JP); Yoshimi Kudo, Yamagata-ken (JP)

Correspondence Address: ARENT FOX PLLC, 1050 CONNECTICUT AVENUE, N.W., SUITE 400, WASHINGTON, DC, 20036, US

(73) Assignees: Pioneer Corporation; Tohoku Pioneer Corporation

(21) Appl. No.: 11/008,219

(22) Filed: Dec. 10, 2004

(30) Foreign Application Priority Data
Feb. 17, 2004 (JP) 2004-40372

(51) Int. Cl. H04R 9/06; H04R 25/00

(52) U.S. Cl. 381/396; 381/398

(57) ABSTRACT

A magnetic circuit driving a diaphragm is located in a sound emission area of the diaphragm which is supported by a frame. A network element is installed on the opposite side of a frame member from the sound emission area of the diaphragm.

### BACKGROUND OF THE INVENTION

1. Field of the Invention

This invention relates to structure of a speaker.

The present application claims priority from Japanese Application No. 2004-40372, the disclosure of which is incorporated herein by reference.

2. Description of the Related Art

Typically, various network elements, such as choke coils, capacitors and resistances, are connected to a speaker for control of audio signals inputted to the speaker.

FIG. 1 illustrates a conventional speaker connected to network elements.

In FIG. 1, the network elements such as choke coils, capacitors and resistances are housed in a control box 1 and connected via an extension cord 2 to a relay terminal 3 mounted on a frame of a speaker P.

In the case of a speaker apparatus having a speaker P connected to such network elements which have been housed in the control box 1 provided independently of the speaker P, the control box 1 is connected to some part of the wiring to the speaker P. For example, for a vehicle-mounted speaker, the wiring must be carried out after providing for a space required for installing the control box 1 in a door of the vehicle, a console or the like. This process makes the installation hard. Further, because the speaker P and the network elements are at a distance from each other, the loss of power causes speaker performance degradation.

For this reason, a speaker having network elements attached to a speaker body as illustrated in FIG. 2 has recently been developed.

Such a speaker is disclosed in Japanese Patent application Laid-open No. 2002-142284, for example.

The conventional speaker as illustrated in FIG. 2 has a network element (choke coil in the example in FIG. 2) N attached to the outer face of a frame Ph of the speaker P.

However, in such a speaker having the network element N attached to the frame Ph of the speaker P, the proximity of the network element N and voice coils Pc of the speaker allows electromagnetic induction generated around the choke coil (i.e. the network element N) to give rise to an induced current in the voice coils Pc, leading to problems of degradation of performance of the speaker P and the like.

### SUMMARY OF THE INVENTION

An object of the present invention is to solve the problems associated with the conventional speakers as described above.

To attain this object, the present invention provides a speaker characterized in that a magnetic circuit driving a diaphragm is provided in a sound emission area close to the diaphragm, and a network element is installed on the opposite side of a frame member, supporting the diaphragm, from the sound emission area of the diaphragm.

In the best mode for carrying out the present invention, a speaker is provided with a tubular-shaped magnetic-circuit supporter that is formed integrally with a frame member forming an outer frame of a speaker and supporting a diaphragm and projects from an inside central portion of the frame member so as to pass through a central portion of the diaphragm from the rear thereof to the sound emission area. A magnetic circuit is installed and supported at a leading end of the magnetic-circuit supporter. Further, a network element of the speaker is installed on a rear face of the frame member that is located at a distance from the position of installation of the magnetic circuit and at a rear end of the magnetic-circuit supporter situated behind the diaphragm.

The speaker according to the best mode outputs sound from the diaphragm upon reception of audio signals via the network element installed on the rear face of the frame member.

For the reception of audio signals, in the speaker, the magnetic circuit is located in the sound emission area close to the diaphragm, whereas the network element is located on the rear face of the frame member. Hence, because the distance between the magnetic circuit and the network element is increased as compared with that in the conventional speaker, the influence of the network element on the magnetic circuit is smaller. In consequence, there is no danger that installing the network element will cause degradation of speaker performance.

Further, the speaker is capable of having the network element installed integrally with the speaker body. For this reason, for example, when the speaker is used as a vehicle-mounted multi-way speaker, significant improvement in ease of installation would be achieved.

Still further, the magnetic circuit of the speaker is located in the sound emission area close to the diaphragm. In other words, the magnetic circuit is able to be situated in the cone shape of the diaphragm, thereby making it possible to reduce the thickness of the speaker.

These and other objects and features of the present invention will become more apparent from the following detailed description with reference to the accompanying drawings.

### BRIEF DESCRIPTION OF THE DRAWINGS

FIG. 1 is a diagram illustrating the structure of a conventional speaker.

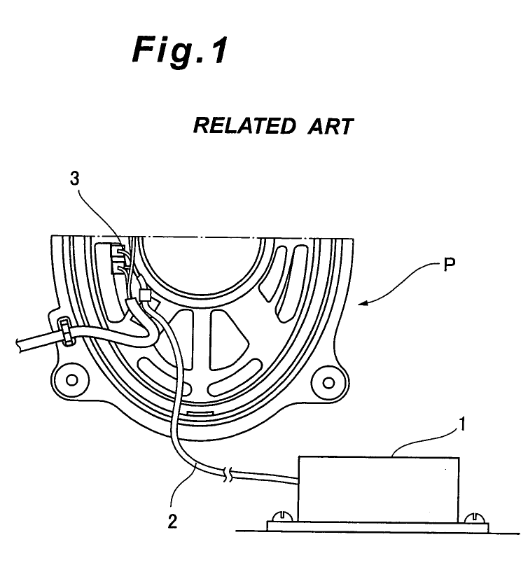

FIG. 2 is a partially sectional view illustrating the structure of another conventional speaker.

FIG. 3 is a sectional view illustrating a first embodiment according to the present invention.

FIG. 4 is a sectional view illustrating a second embodiment according to the present invention.

### DETAILED DESCRIPTION OF THE PREFERRED EMBODIMENTS

First Embodiment

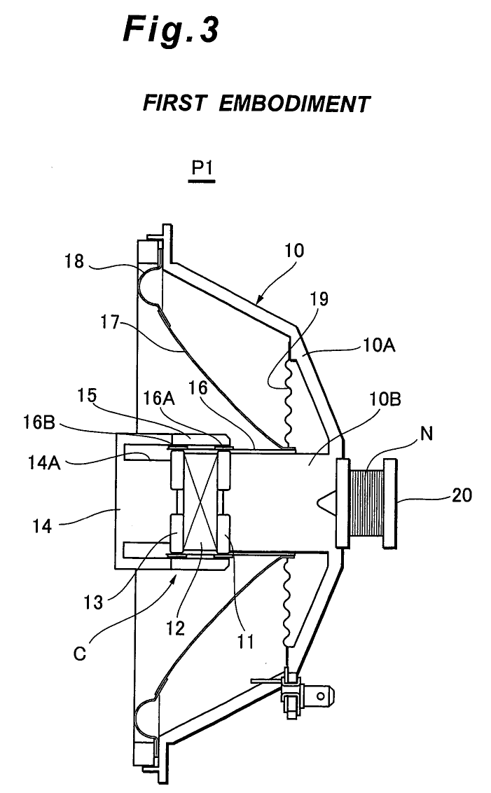

FIG. 3 is a sectional view illustrating the first embodiment of a speaker according to the present invention.

In FIG. 3, the speaker P1 has a frame 10 that includes a substantially cup-shaped frame body 10A forming the outside wall of the speaker, and a cylinder-shaped magnetic-circuit supporter 10B integrated with the frame body 10A and concentrically extending from the innermost center of the frame body 10A toward the open end thereof.

A ring-shaped first plate 11 is secured concentrically on the leading end face of the magnetic-circuit supporter 10B (the left end face in FIG. 3) The first plate 11 is larger in outer diameter than the magnetic-circuit supporter 10B. A tubular-shaped magnet 12 is secured concentrically on the front face of the first plate 11 (the left face in FIG. 3), and is smaller in outer diameter than the first plate 11.

In turn, a second plate 13 of the same outer diameter as that of the first plate 11 is secured concentrically on the front face of the magnet 12 (the left face in FIG. 3).

A tubular-shaped support frame 14 is secured concentrically on the front face of the second plate 13, and is larger in outer diameter than the first plate 11, the magnet 12 and the second plate 13.

The support frame 14 has a groove 14A formed in an annular shape concentric with the body and in the rear face of the support frame 14. The groove 14A has a smaller inner diameter and a larger outer diameter than the outer diameter of the first plate 11 and the second plate 13.

A depth of the groove 14A (width in the direction of the center line of the support frame 14) is set greater than the excursion (or the amount of travel) of a diaphragm which will be described later.

A ring-shaped yoke 15 is fixed concentrically on the rear face of the support frame 14 (the right face in FIG. 3). The yoke 15 has an inner diameter equal to the outer diameter of the groove 14A of the support frame 14 (the diameter of the inner face of the outside wall of the groove 14A). A magnetic gap is provided between the inner peripheral face of the yoke 15 and the outer peripheral faces of the first plate 11 and the second plate 13.

In this manner, a magnetic circuit C is formed by the first plate 11, magnet 12, second plate 13, support frame 14, and the yoke 15.

Further, a voice coil bobbin 16 vibrating in the direction of the center line is fitted concentrically over the supporter 10B of the frame 10, the first plate 11, the magnet 12 and the second plate 13. A front portion of the voice coil bobbin 16 (the left portion in FIG. 3) is inserted into the magnetic gap created between the yoke 15 and the first and second plates 11 and 13.

A first voice coil 16A is wound on a portion of the voice coil bobbin 16 facing the outer peripheral face of the first plate 11 inside the magnetic gap. A second voice coil 16B is wound on a portion of the voice coil bobbin 16 facing the outer peripheral face of the second plate 13 inside the magnetic gap.

A cone-shaped diaphragm 17 is secured at its inner circle end to the outer periphery of the rear end of the voice coil bobbin 16. The outer circle end of the diaphragm 17 is supported through an edge 18 by the periphery of the front end of the frame body 10A.

A damper 19 is interposed between the frame body 10A and the portion of the rear end of the voice coil bobbin 16 which is coupled to the diaphragm 17. The damper 19 supports the voice coil bobbin 16 and the diaphragm 17 and allows them to vibrate in the direction of the center line.

A network element installation member 20 is provided in a central portion of the rear face of the frame 10 (the rear end face of the magnetic-circuit supporter 10B) . A network element (choke coil in the example shown in FIG. 3) N is installed on the network element installation member 20, and supported integrally with the frame body 10A.

For audio output from the speaker P1, an audio signal is inputted to the speaker through the network element N supported by the network element installation member 20, and therefore electric current passes through the first voice coil 16A and the second voice coil 16B. Thereupon, interaction between the electric current and a magnetic field produced by the magnet 12 causes vibration of the voice coil bobbin 16 in the direction of the center line (in the right-left direction in FIG. 3). Thus, the diaphragm 17 vibrates so as to output sound.

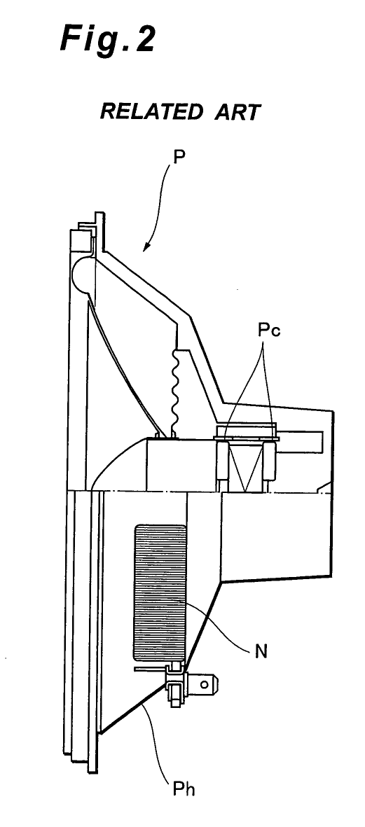

In the speaker P1, the magnetic circuit C is located in the sound emission area close to the diaphragm 17 (i.e. on the left hand in FIG. 3), whereas the network element N is located behind the frame body 10A. Hence, the distance between the magnetic circuit C and the network element N is increased as compared with that in the conventional speaker as shown in FIG. 2, and therefore the influence of the network element N on the magnetic circuit C is smaller. For cases where the network element N is a choke coil, the speaker P1 is capable of preventing degradation of speaker performance and the like which will be caused by a situation in which electromagnetic induction generated around the choke coil gives rise to an induced current in the first voice coil 16A and the second voice coil 16B.

Further, because the network element N is installed integrally with the speaker body, when the speaker P1 is used as, e.g., a vehicle-mounted multi-way speaker, it is possible to significantly improve ease of installation.

Still further, the magnetic circuit C of the speaker P1 is located in the sound emission area of the cone-shaped diaphragm 17. In other words, the magnetic circuit C is situated inside the cone shape of the diaphragm 17, thereby making it possible to reduce the thickness of the speaker.

Second Embodiment

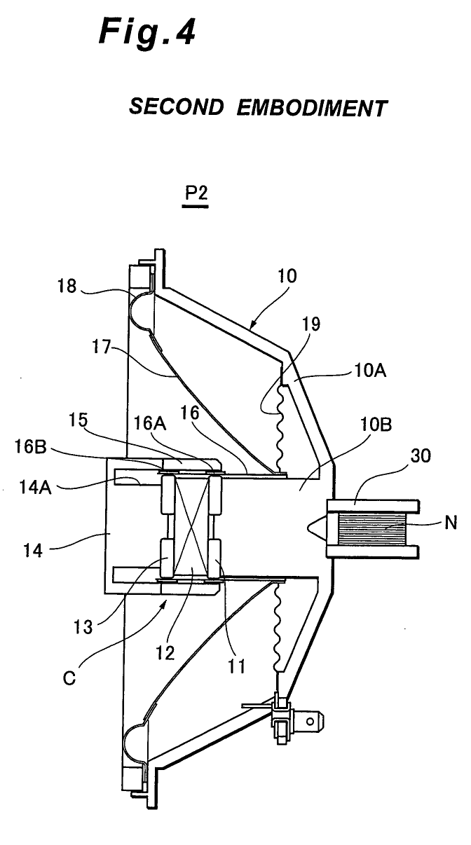

FIG. 4 is a sectional view illustrating the second embodiment of the speaker according to the present invention.

The choke coil, i.e. the network element N, of the speaker P1 of the first embodiment is wound about the center line of the network element installation member 20 which is coaxial with the frame 10. However, in a speaker P2 in the second embodiment shown in FIG. 4, a network element installation member 30 is attached to a central portion of the rear face of a frame 10 such that its center line and the center line of the frame 10 form right angles. A choke coil which is a network element N is wound on the network element installation member 30 about the center line at right angles to the center line of the frame 10.

The remaining structure of the speaker P2 is the same as that of the speaker P1 in the first embodiment, and therefore the same components are designated by the same reference numerals as those in FIG. 3.

As in the case of the speaker P1 in the first embodiment, in the speaker P2, the magnetic circuit C is located in front of the diaphragm 17, whereas the network element N is located behind the frame body 10A. Hence, the distance between the magnetic circuit C and the network element N is increased as compared with that in the conventional speaker as shown in FIG. 2, and therefore the influence of the network element N on the magnetic circuit C is smaller. For cases where the network element N is a choke coil, the speaker P2 is capable of preventing degradation of speaker performance and the like which will be caused by the situation in which electromagnetic induction generated around the choke coil gives rise to an induced current in the first voice coil 16A and the second voice coil 16B.

Further, because the network element N is installed integrally with the speaker body, when the speaker P2 is used as a vehicle-mounted multi-way speaker, for example, significant improvement in ease of installation is achieved.

Still further, the magnetic circuit C of the speaker P2 is located in the sound emission area of the cone-shaped diaphragm 17. In other words, the magnetic circuit C is situated inside the cone shape of the diaphragm 17, thereby making it possible to reduce the thickness of the speaker.

The terms and description used herein are set forth by way of illustration only and are not meant as limitations. Those skilled in the art will recognize that numerous variations are possible within the spirit and scope of the invention as defined in the following claims.

1. A speaker, comprising:
a diaphragm;
a magnetic circuit that is provided in a sound emission area of the diaphragm and drives the diaphragm;
a frame member that supports the diaphragm; and
a network element that is installed on the opposite side of the frame member from the sound emission area of the diaphragm.

2. A speaker according to claim 1,
further comprising a magnetic-circuit supporter that projects from an inside central portion of the frame member forming an outer frame of the speaker and supporting the diaphragm and passes through a central portion of the diaphragm from the rear thereof to the sound emission area,
wherein the magnetic circuit is provided at a leading end of the magnetic-circuit supporter, and the network element is installed at a rear end of the magnetic-circuit supporter situated behind the diaphragm.

3. A speaker according to claim 2, wherein the network element is located on a rear face of the frame member.

4. A speaker according to claim 1, wherein the network element is a choke coil.

5. A speaker according to claim 1, wherein the network element installed on the frame member has a center line positioned substantially parallel to a center line of the frame member.

6. A speaker according to claim 1, wherein the network element installed on the frame member has a center line extending approximately at right angles to a center line of the frame member.
